(19) United States
(12) Patent Application Publication
(10) Pub. No.: US 2012/0257117 A1
(43) Pub. Date: Oct. 11, 2012

(54) TRANSMITTING VIDEO/AUDIO CONTENT FROM A MOBILE COMPUTING OR COMMUNICATIONS DEVICE

(75) Inventors: Shay Freundlich, Sunnyvale, CA (US); Zvi Reznic, Tel Aviv (IL)

(73) Assignee: AMIMON LTD, Herzlia (IL)

(21) Appl. No.: 13/500,918

(22) PCT Filed: Oct. 20, 2009
(86) PCT No.: PCT/IB2010/051181

§ 371 Date: Jun. 18, 2012

(30) Foreign Application Priority Data
Oct. 20, 2009 (US) 61253151

(51) Int. Cl. H04N 5/38

(52) U.S. Cl. 348/723; 348/E05.093

(57) ABSTRACT

Disclosed is a method, circuit and system for facilitating transmission of video and/or audio content from a computing/communications device such as Personal Computer, Cellular Phone, Smart-Phone, Personal Digital Assistant (“PDA”), Laptop Computer, Tablet, E-Book reader and/or any variation thereof. Video/audio content stored on, generated or received by, or otherwise displayable upon a computing/communications device may be at least partially processed using computational resources (e.g. central processing unit (CPU), graphics processing unit (GPU), digital signal processor (DSP), application processor, etc.) utilized by another application of the device. The video/audio content may be transmitted using one or more communication resources (e.g. Wi-Fi) utilized by another application of the device.

### FIELD OF THE INVENTION

Some embodiments relate generally to the field of communication and, more particularly, to methods, circuits & systems for transmitting video/audio content from a mobile computing or communications device and devices implementing said methods, circuits & systems.

### BACKGROUND

Wireless communication has rapidly evolved over the past decades. Even today, when high performance and high bandwidth wireless communication equipment is made available there is demand for even higher performance at a higher data rates, which may be required by more demanding applications.

Video/audio content may be generated or received by various mobile computing or communications devices, for example, a laptop computer, a netbook, a tablet computer, a smart phone, a game console, an e-book reader, or any other suitable mobile computing or communications device. In many devices, for example, video/audio content is generated by the device to view on an integral viewing screen, store or transmit to a functionally associated device. Video/audio content may be received from a functionally associated device, an internal or external memory, a data server, a streaming application, a removable media storage device or any other suitable media storage.

In many cases, the integral viewing screen may be too small and/or may be of poor quality for certain applications (e.g. high definition movie viewing). It may be desired to place a screen or projector at a location in a distance of at least a few meters from the video source. This trend is becoming more common as flat-screen displays, e.g., plasma or Liquid Crystal Display (LCD) televisions are hung on a wall. Connection of such a display or projector to the video source through cables is generally undesired for aesthetic reasons and/or installation convenience. Thus, wireless transmission of the video signals from the video source to the screen is preferred.

WHDI—Wireless Home Digital Interface is a standard for wireless high-definition video connectivity between a video source and video sink (e.g. display). It provides a high-quality, uncompressed wireless link which can support delivery of equivalent video data rates of up to 3 Gbit/s (including uncompressed 1080p) in a 40 MHz channel within the 5 GHz unlicensed band. Equivalent video data rates of up to 1.5 Gbit/s (including uncompressed 1080i and 720p) can be delivered on a single 20 MHz channel in the 5 GHz unlicensed band, conforming to worldwide 5 GHz spectrum regulations. Range is beyond 100 feet (30 m), through walls, and latency is less than one millisecond. For mobile computing or communications devices, WHDI may be adapted for the available computing power and the integral radio-frequency transmitter.

There is thus a need in the field of wireless communication for improved methods, circuits & systems for transmitting video/audio content from a mobile computing or communications device and devices implementing said methods, circuits & systems.

### SUMMARY OF THE INVENTION

The present invention is a method, circuit and system for facilitating transmission of video and/or audio content from a computing/communications device such as Personal Computer, Cellular Phone, Smart-Phone, Personal Digital Assistant (“PDA”), Laptop Computer, Tablet, E-Book reader and/or any variation thereof. According to some embodiments of the present invention, video/audio content stored on, generated or received by, or otherwise displayable upon a computing/communications device may be at least partially processed using computational resources (e.g. central processing unit (CPU), graphics processing unit (GPU), digital signal processor (DSP), application processor, etc.) utilized by another application of the device. According to further embodiments of the present invention the video/audio content may be transmitted using one or more communication resources (e.g. Wi-Fi) utilized by another application of the device.

According to some embodiments of the present invention, the video/audio content to be transmitted by a device may have been stored, generated or received by the device in varied forms and/or formats. According to further embodiments of the present invention, video/audio content may be stored on the device or received by the device in a compressed video format such as MPEG-4 or H.264. A compressed video format may include video/audio content (i.e. pixel data and/or audio samples) that was previously grouped into blocks and converted into data frame coefficients (e.g. frequency coefficients) using a discrete cosine transform or any other de-correlating transformation. The data frame coefficients may have been further processed using inter-frame compression techniques.

According to some embodiments of the present invention, the device may decode the stored or received compressed video/audio content prior to displaying the content. According to further embodiments of the present invention, the device may decode the video/audio content into data frame coefficients before further decoding the data frame coefficients into displayable data (i.e. pixel data). According to further embodiments of the present invention, the data frame coefficients may be intercepted (i.e. copied and processed prior to or in parallel with another application of the device) and processed for transmission by the device using available computational resources of the device.

According to further embodiments of the present invention, video/audio content may be transmitted using transmission symbols comprised of intercepted data frame coefficients. According to further embodiments of the present invention, low spatial frequency coefficients (i.e. DC coefficients, and/or near DC coefficients) may be represented in a coarse, (i.e. digital) manner. According to further embodiments of the present invention, the low spatial frequency coefficients may be represented as one or more of a plurality of constellation points of a symbol by performing a quantization on their values and mapping them. According to some embodiments of the present invention, relatively higher frequency coefficients and the quantization errors of the DC and the near DC components may be mapped as fine-constellation points thus providing the fine granularity (i.e. analog-like) values that at an extreme fineness provides for a continuous representation of these values.

Further details with regard to methods and systems of uncompressed, wireless transmission of video are described in U.S. patent application Ser. No. 11/551,641 which application is hereby incorporated by reference in its entirety.

According to some embodiments of the present invention, video/audio content stored on, generated or received by, or otherwise displayable upon the device may be in a pixel data format. According to further embodiments of the present invention, pixel data video/audio content may be accessible from a buffer functionally associated with or otherwise integral with the device (e.g. a display buffer associated with a GPU). According to further embodiments of the present invention, selected pixel data may be sent to the processing unit for data frame coefficient generation.

According to some embodiments of the present invention, the processing unit may group the selected pixel data into pixel blocks. According to further embodiments of the present invention where the processing unit is a GPU, multiple blocks of pixel data may be processed in parallel. According to further embodiments of the present invention, the blocks of pixel data may be converted into data frame coefficients (e.g. frequency coefficients) using a discrete cosine transform or any other de-correlating transformation. According to further embodiments of the present invention, the data frame coefficients may be processed for transmission using available computational resources of the device prior to or in parallel with another application of the device.

According to some embodiments of the present invention, video/audio content may be transmitted using transmission symbols comprised of data frame coefficients generated by the processing unit. According to further embodiments of the present invention where the processing unit is a GPU, data frame coefficients may be processed in parallel. According to further embodiments of the present invention, low spatial frequency coefficients (i.e. DC coefficients, and/or near DC coefficients) may be represented in a coarse, (i.e. digital) manner. According to further embodiments of the present invention, the low spatial frequency coefficients may be represented as one or more of a plurality of constellation points of a symbol by performing a quantization on their values and mapping them. The mapping may be performed by an integral application processor. According to some embodiments of the present invention, relatively higher frequency coefficients and the quantization errors of the DC and the near DC components may be mapped as fine-constellation points thus providing the fine granularity (i.e. analog-like) values that at an extreme fineness provides for a continuous representation of these values.

A connection between a processing unit and a communication resource may have limited bandwidth preventing substantially real-time uncompressed video transmission. According to some embodiments of the present invention, video/audio data frame coefficients may be compressed before sending them to the communication resource. According to further embodiments of the present invention, the video/audio data frame coefficients may be decompressed after they are received from the processing unit.

According to some embodiments of the present invention, a communication resource may be a quadrature amplitude modulation (QAM) based transmitter, an orthogonal frequency-division multiplexing (OFDM) based transmitter, or any other transmitter adapted to transmit data using transmission symbols. According to further embodiments of the present invention, transmission symbol processing may be performed by an integral DSP or by a fast Fourier transformer (FFT) co-processor. According to further embodiments of the present invention, the communication resource may be a circuit designed for transmission over a telecommunication network (e.g. wide area network, metropolitan area network, or local area network) and adapted to transmit data using fine-valued (analog-like) transmission symbols.

According to some embodiments of the present invention where the communication resource may be a circuit designed for transmission over a telecommunication network, the circuit may include a baseband processing circuit in addition to an RF transmission circuit. The circuit may include a baseband bypass for up-converting and transmitting video/audio content based transmission symbols without additional baseband processing. According to further embodiments of the present invention where there is no baseband bypass, the video/audio content based transmission symbols may be transmitted by an additional RF transmission circuit designed for up-converting and transmitting video/audio content based transmission symbols.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an exemplary mobile computing device and mobile communications device arrangement, according to some embodiments of the present invention;

FIG. 2A is a functional block diagram of an exemplary computing and/or communications device according to some embodiments of the present invention where the communication resource includes coefficient and symbol generators;

FIG. 2B is a functional block diagram of an exemplary computing and/or communications device according to some embodiments of the present invention where the computational resource includes coefficient and symbol generators;

FIG. 3 is a functional block diagram of an exemplary coefficient and symbol generator according to some embodiments of the present invention;

FIG. 4 is a schematic diagram showing computational parallelization in a GPU according to some embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications, medical applications, commercial applications, or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, portable media players, cell phones, mobile devices, and/or automobile A/V accessories. In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories. In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

Some demonstrative embodiments may be implemented to communicate wireless-video signals over a wireless-video communication link, as well as Wireless-Local-Area-Network (WLAN) signals over a WLAN link. Such implementation may allow a user, for example, to play a movie, e.g., on a laptop computer, and to wirelessly transmit video signals corresponding to the movie to a video destination, e.g., a screen, while maintaining a WLAN connection, e.g., with the Internet and/or one or more other devices connected to a WLAN network. In one example, video information corresponding to the movie may be received over the WLAN network, e.g., from the Internet.

According to some embodiments of the present invention, there may be a circuit for transmitting video/audio content from a computing or communications device comprising a shared computational resource and a communication resource. According to further embodiments of the present invention, the shared computational resource may be adapted to intercept the video/audio content and convert the content into transmission symbols. The communication resource may be adapted to up-convert and transmit the transmission symbols.

According to some embodiments of the present invention, the video/audio content may be intercepted as data frame spatial coefficients or a compressed representation of data frame spatial coefficients. According to further embodiments of the present invention, the shared computational resource may be further adapted to map the data frame spatial coefficients to a transmission symbol map.

According to some embodiments of the present invention, the shared computational resource may be selected from the group consisting of a mobile device application processor, a personal computer processor, a mobile device graphics processor, a personal computer graphics processor, a desk-top-box graphics processor, a desk-top-box applications processor, a digital signal processor, a discrete transform engine, a transmitter baseband processor, a programmable gate array, a field programmable gate array and an application specific integrated circuit.

According to some embodiments of the present invention, the video/audio content may be intercepted as pixel data. According to further embodiments of the present invention, the shared computational resource may be further adapted to generate data frame spatial coefficients by processing blocks of pixel data through a de-correlating transform. The de-correlating transform may be a discrete cosine transform.

According to some embodiments of the present invention, the shared computational resource may be further adapted to map the data frame coefficients to a transmission symbol map.

According to some embodiments of the present invention, the shared computational resource may be selected from the group consisting of a mobile device application processor, a personal computer processor, a mobile device graphics processor, a personal computer graphics processor, a desk-top-box graphics processor, a desk-top-box applications processor, a digital signal processor, a discrete transform engine, a transmitter baseband processor, a programmable gate array, a field programmable gate array and an application specific integrated circuit. According to further embodiments of the present invention, the shared computational resource may be a graphics processor adapted for parallel processing. The graphics processor may be adapted to perform pixel block processing or transmission symbol processing in parallel.

According to some embodiments of the present invention, the communication resource may be a shared transmitter. According to further embodiments of the present invention, the shared transmitter may include a shared radio frequency integrated circuit (RFIC). According to further embodiments of the present invention, the shared transmitter may include a shared baseband integrated circuit (BBIC). According to some embodiments of the present invention, the communication resource may be adapted to be an orthogonal frequency-division multiplexing (OFDM) transmitter.

According to some embodiments of the present invention, there may be a computing device comprising a shared computational resource and a communication resource. According to further embodiments of the present invention, the shared computational resource may be adapted to intercept the video/audio content and convert the content into transmission symbols. According to further embodiments of the present invention, the communication resource may be adapted to up-convert and transmit the transmission symbols.

According to some embodiments of the present invention, the video/audio content may be intercepted as data frame spatial coefficients or a compressed representation of data frame spatial coefficients. According to further embodiments of the present invention, the shared computational resource may be further adapted to map the data frame spatial coefficients to a transmission symbol map. According to further embodiments of the present invention, the shared computational resource may be selected from the group consisting of a mobile device application processor, a personal computer processor, a mobile device graphics processor, a personal computer graphics processor, a desk-top-box graphics processor, a desk-top-box applications processor, a digital signal processor, a discrete transform engine, a transmitter baseband processor, a programmable gate array, a field programmable gate array and an application specific integrated circuit.

According to some embodiments of the present invention, the video/audio content may be intercepted as pixel data. According to further embodiments of the present invention, the shared computational resource may be further adapted to generate data frame spatial coefficients by processing blocks of pixel data through a de-correlating transform. According to further embodiments of the present invention, the de-correlating transform may be a discrete cosine transform. According to further embodiments of the present invention, the shared computational resource may be further adapted to map the data frame coefficients to a transmission symbol map. According to further embodiments of the present invention, the shared computational resource may be selected from the group consisting of a mobile device application processor, a personal computer processor, a mobile device graphics processor, a personal computer graphics processor, a desk-top-box graphics processor, a desk-top-box applications processor, a digital signal processor, a discrete transform engine, a transmitter baseband processor, a programmable gate array, a field programmable gate array and an application specific integrated circuit.

According to some embodiments of the present invention, the shared computational resource may be a graphics processor adapted for parallel processing. According to further embodiments of the present invention, the graphics processor may be adapted to perform pixel block processing or transmission symbol processing in parallel.

According to some embodiments of the present invention, the communication resource may be a shared transmitter. According to further embodiments of the present invention, the shared transmitter may include a shared radio frequency integrated circuit (RFIC). According to further embodiments of the present invention, the shared transmitter may include a shared baseband integrated circuit (BBIC). According to some embodiments of the present invention, the communication resource may be adapted to be an orthogonal frequency-division multiplexing (OFDM) transmitter.

According to some embodiments of the present invention, there may be a communications device comprising a shared computational resource and a communication resource. According to further embodiments of the present invention, the shared computational resource may be adapted to intercept the video/audio content and convert the content into transmission symbols. According to further embodiments of the present invention, the communication resource may be adapted to up-convert and transmit the transmission symbols.

According to some embodiments of the present invention, the video/audio content may be intercepted as data frame spatial coefficients or a compressed representation of data frame spatial coefficients. According to further embodiments of the present invention, the shared computational resource may be further adapted to map the data frame spatial coefficients to a transmission symbol map. According to further embodiments of the present invention, the shared computational resource may be selected from the group consisting of a mobile device application processor, a personal computer processor, a mobile device graphics processor, a personal computer graphics processor, a desk-top-box graphics processor, a desk-top-box applications processor, a digital signal processor, a discrete transform engine, a transmitter baseband processor, a programmable gate array, a field programmable gate array and an application specific integrated circuit.

According to some embodiments of the present invention, the video/audio content may be intercepted as pixel data. According to further embodiments of the present invention, the shared computational resource may be further adapted to generate data frame spatial coefficients by processing blocks of pixel data through a de-correlating transform. According to further embodiments of the present invention, the de-correlating transform may be a discrete cosine transform. According to further embodiments of the present invention, the shared computational resource may be further adapted to map the data frame coefficients to a transmission symbol map. According to further embodiments of the present invention, the shared computational resource may be selected from the group consisting of a mobile device application processor, a personal computer processor, a mobile device graphics processor, a personal computer graphics processor, a desk-top-box graphics processor, a desk-top-box applications processor, a digital signal processor, a discrete transform engine, a transmitter baseband processor, a programmable gate array, a field programmable gate array and an application specific integrated circuit.

According to some embodiments of the present invention, the shared computational resource may be a graphics processor adapted for parallel processing. According to further embodiments of the present invention, the graphics processor may be adapted to perform pixel block processing or transmission symbol processing in parallel.

According to some embodiments of the present invention, the communication resource may be a shared transmitter. According to further embodiments of the present invention, the shared transmitter may include a shared radio frequency integrated circuit (RFIC). According to further embodiments of the present invention, the shared transmitter may include a shared baseband integrated circuit (BBIC). According to some embodiments of the present invention, the communication resource may be adapted to be an orthogonal frequency-division multiplexing (OFDM) transmitter.

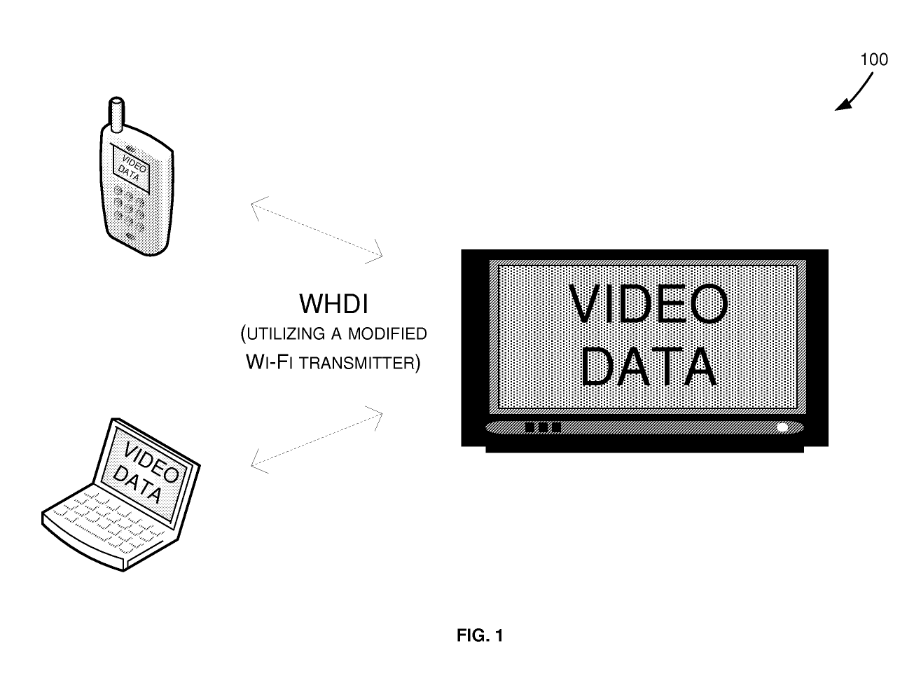

Now turning to FIG. 1, there is shown an exemplary mobile computing device and mobile communications device arrangement (100), according to some embodiments of the present invention. According to some embodiments of the present invention, the mobile computing device and/or the mobile communications device may transmit video/audio content to an external display (e.g. a monitor, a projector or a television) via a WHDI wireless transmission link utilizing a modified Wi-Fi transmitter.

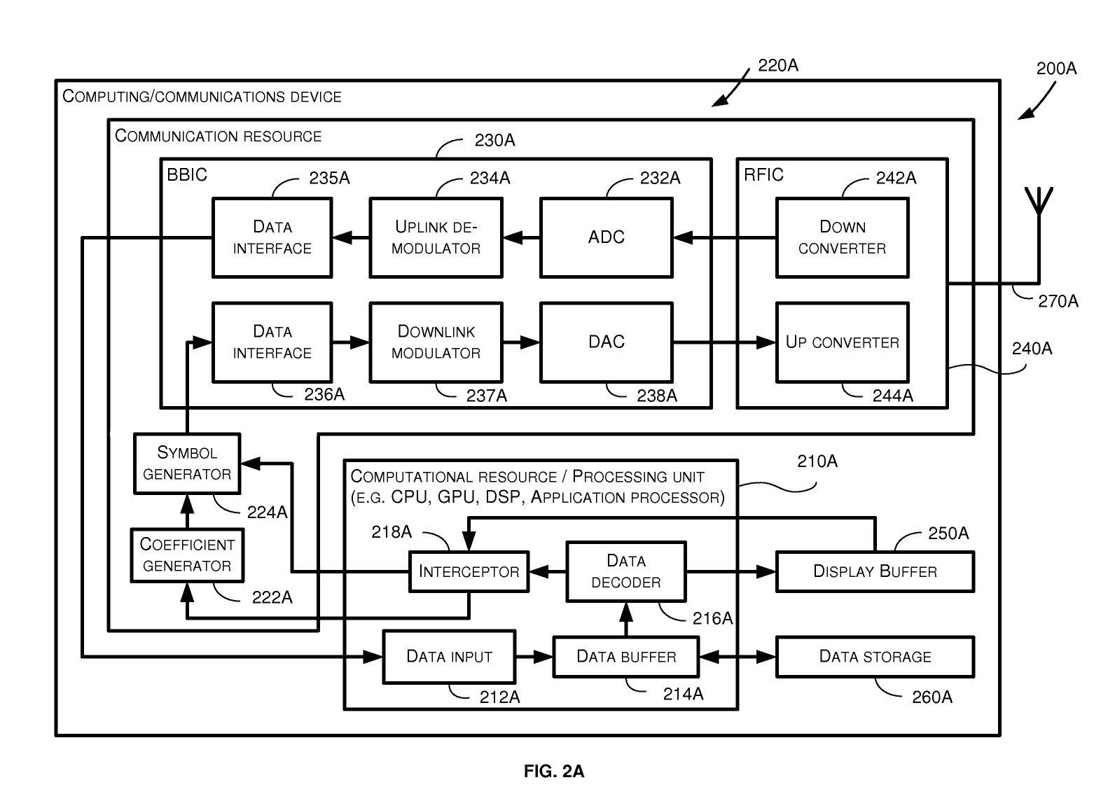

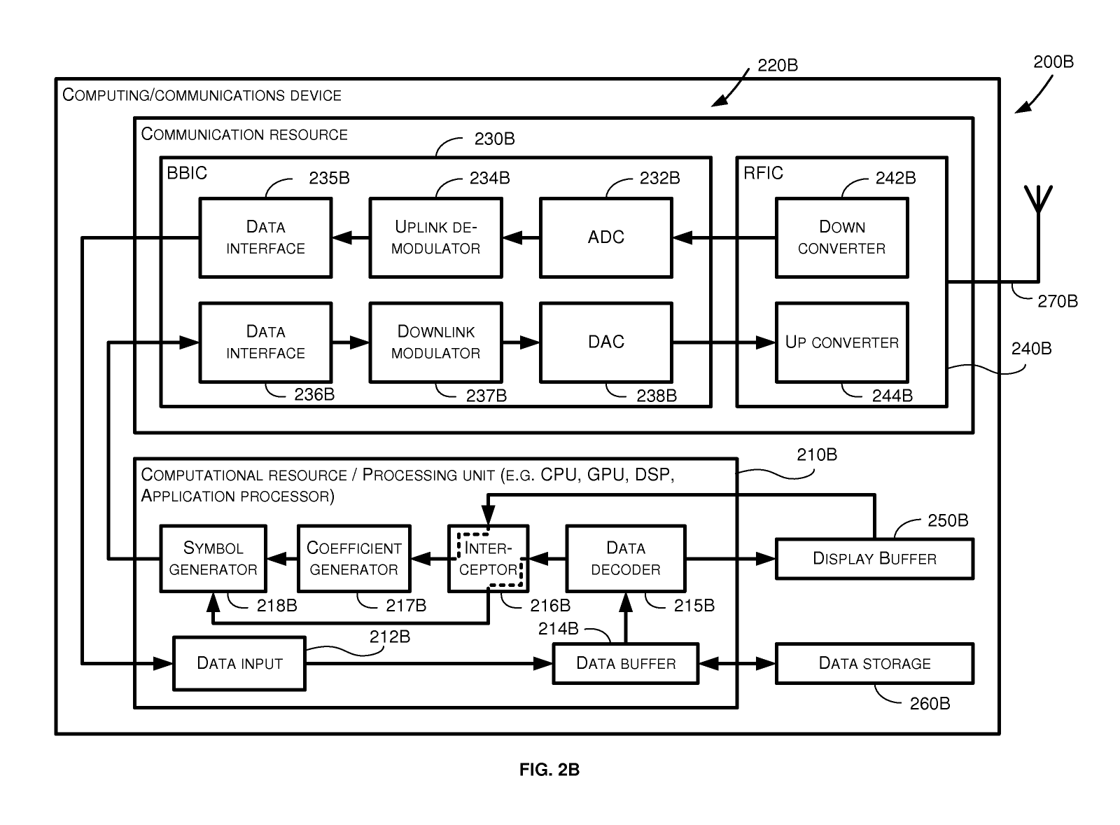

Now turning to FIG. 2A, there is shown a functional block diagram of an exemplary computing and/or communications device according to some embodiments of the present invention where the communication resource includes coefficient and symbol generators.

According to some embodiments of the present invention, a computing/communications device (200A) may include a communication resource (220A) for transmitting and receiving video/audio content and a computational resource/processing unit (210A) for processing, coding, decoding and/or formatting the video/audio content. The computing/communications device (200A) may include a display buffer (250A) for buffering video data to be displayed on an integral or functionally associated display and a data storage circuit or device (260A) for substantially long term storage of data.

According to some embodiments of the present invention, the communication resource (220A) may include a baseband integrated chip (BBIC) (230A) and a radio-frequency integrated chip (RFIC) (240A) to transmit and receive data signals along with functionally associated antenna(s) (270A). According to further embodiments of the present invention, the RFIC (240A) may include a down converter (242A) for receiving and down converting uplink data signals and an up converter (244A) for up converting and transmitting downlink data signals.

According to some embodiments of the present invention, the BBIC (230A) may include a receive chain comprising an analog to digital converter (ADC) (232A), an uplink demodulator (234A) and a data interface (235A). According to further embodiments of the present invention, the ADC (232A) may receive analog signals from the down converter (242A) and convert them into a corresponding digital form for the uplink demodulator (234A). The uplink demodulator (234A) may extract a data bearing signal from the received signal for the data interface (235A) adapted to receive data bearing signals and to send them to a functionally associated computational resource and/or processing unit (210A).

According to some embodiments of the present invention, the BBIC (230A) may include a transmission chain comprising a data interface (236A), a downlink modulator (237A) and a digital to analog converter (DAC) (238A). According to further embodiments of the present invention, the data interface (236A) may receive transmission symbols and send them to the downlink modulator (237A) to generate a corresponding digital transmission signal. The DAC (238A) may convert the transmission signal into a corresponding analog transmission signal for the up converter (244A) to transmit the signal.

According to some embodiments of the present invention, the communication resource (220A) may include a coefficient generator (222A) to generate de-correlated data coefficients from received video/audio content. The communication resource (220A) may also include a symbol generator (224A) to convert the data coefficients into transmission symbols utilizing a predetermined or any suitable mapping scheme.

According to some embodiments of the present invention, the computational resource/processing unit (210A) may include a data input (212A), a data buffer (214A), a data decoder (216A) and an interceptor (218A). According to further embodiments of the present invention, the data input (212A) may receive coded video/audio content and send the data to the data buffer (214A). The data buffer (214A) may send the data to a functionally associated or integral data storage circuit or device (260A) for substantially long term storage, or to the data decoder (216A) for substantially real time data processing. The data buffer (214A) may receive data from the data storage (260A) for processing previously stored data. According to further embodiments of the present invention, the data decoder (216A) may be adapted to decode received video data for a functionally associated or integral display buffer (250A). According to further embodiments of the present invention, the interceptor (218A) may take decoded data from the data decoder (216A) in coefficient form and send the data to the symbol generator (224A) to convert the data coefficients into transmission symbols. The interceptor (218A) may take display-ready data from the display buffer (250A) and send the data to the coefficient generator (222A) to convert the data into de-correlated data coefficients before sending the coefficients to the symbol generator (224A).

According to some embodiments of the present invention, an available data link between the computational resource (210A) and the communication resource (220A) may have a substantially low maximum data rate. According to further embodiments of the present invention, the interceptor (218A) may compress decoded data to a size suitable for transmission over the available data link before sending the data to the communication resource (220A). The communication resource may perform decompression on the received data before the data is processed by the coefficient generator (222A) or the symbol generator (224A).

Now turning to FIG. 2B, there is shown a functional block diagram of an exemplary computing and/or communications device according to some embodiments of the present invention where the computational resource includes coefficient and symbol generators.

According to some embodiments of the present invention, a computing/communications device (200B) may include a communication resource (220B) for transmitting and receiving video/audio content and a computational resource/processing unit (210B) for processing, coding, decoding and/or formatting the video/audio content. The computing/communications device (200B) may include a display buffer (250B) for buffering video data to be displayed on an integral or functionally associated display and a data storage circuit or device (260B) for substantially long term storage of data.

According to some embodiments of the present invention, the communication resource (220B) may include a baseband integrated chip (BBIC) (230B) and a radio-frequency integrated chip (RFIC) (240B) to transmit and receive data signals along with functionally associated antenna(s) (270B). According to further embodiments of the present invention, the RFIC (240B) may include a down converter (242B) for receiving and down converting uplink data signals and an up converter (244B) for up converting and transmitting downlink data signals.

According to some embodiments of the present invention, the BBIC (230B) may include a receive chain comprising an analog to digital converter (ADC) (232B), an uplink demodulator (234B) and a data interface (235B). According to further embodiments of the present invention, the ADC (232B) may receive analog signals from the down converter (242B) and convert them into a corresponding digital form for the uplink demodulator (234B). The uplink demodulator (234B) may extract a data bearing signal from the received signal for the data interface (235B) adapted to receive data bearing signals and to send them to a functionally associated computational resource and/or processing unit (210B).

According to some embodiments of the present invention, the BBIC (230B) may include a transmission chain comprising a data interface (236B), a downlink modulator (237B) and a digital to analog converter (DAC) (238B). According to further embodiments of the present invention, the data interface (236B) may receive transmission symbols and send them to the downlink modulator (237B) to generate a corresponding digital transmission signal. The DAC (238B) may convert the transmission signal into a corresponding analog transmission signal for the up converter (244B) to transmit the signal.

According to some embodiments of the present invention, the computational resource/processing unit (210B) may include a data input (212B), a data buffer (214B), a data decoder (215B), an interceptor (216B) a coefficient generator (217B) and a symbol generator (218B). According to further embodiments of the present invention, the data input (212B) may receive coded video/audio content and send the data to the data buffer (214B). The data buffer (214B) may send the data to a functionally associated or integral data storage circuit or device (260B) for substantially long term storage, or to the data decoder (215B) for substantially real time data processing. The data buffer (214B) may receive data from the data storage (260B) for processing previously stored data. According to further embodiments of the present invention, the data decoder (215B) may be adapted to decode received video data for a functionally associated or integral display buffer (250B). According to further embodiments of the present invention, the interceptor (216B) may take decoded data from the data decoder (215B) in coefficient form and send the data to the symbol generator (218B) to convert the data coefficients into transmission symbols utilizing a predetermined or any suitable mapping scheme. The interceptor (216B) may take display-ready data from the display buffer (250B) and send the data to the coefficient generator (217B) to convert the data into de-correlated data coefficients before sending the coefficients to the symbol generator (218B).

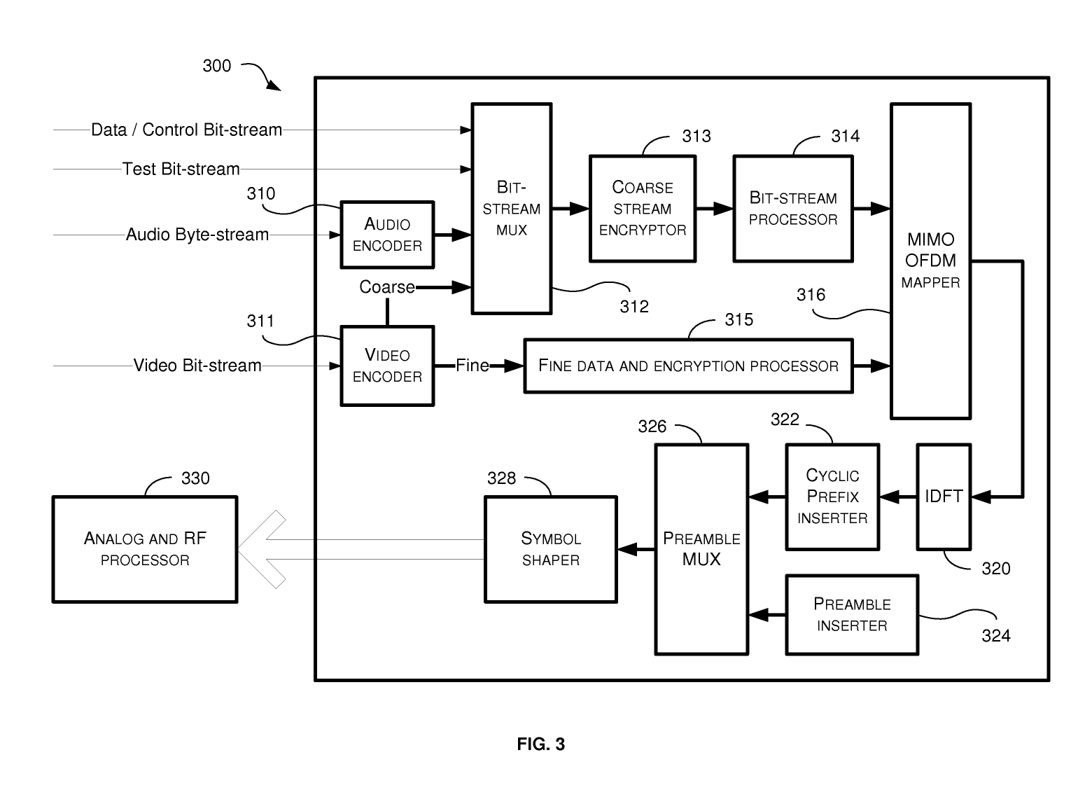

Now turning to FIG. 3, there is shown a functional block diagram of an exemplary coefficient and symbol generator (300) according to some embodiments of the present invention.

According to some embodiments of the present invention, the coefficient and symbol generator (300) may include a bit-stream mux (312) that may be input with a data/control bit-stream and a test bit-stream. According to further embodiments of the present invention, the mux (312) may be input with an audio byte-stream after the stream is processed by a functionally associated or integral audio encoder (310). According to further embodiments of the present invention, the mux (312) may be input with a coarse (i.e. analog-like) data set generated by a functionally associated or integral video encoder (311) after processing a video bit-stream. According to further embodiments of the present invention, the mux (312) may send received data to a functionally associated or integral coarse stream encryptor (313) for encryption (e.g. Advanced Encryption Standard—AES). The encrypted data may be sent to a functionally associated or integral bit-stream processor (314) for processing (e.g. convolutional encoding). According to further embodiments of the present invention, the processed coarse stream may be sent to a MIMO OFDM mapper (316) for some form of coarse, constellation, shape and/or analog mapping.

According to some embodiments of the present invention, the video encoder (311) may output a fine data set to a functionally associated or integral fine data and encryption processor (315) for processing (e.g. Hadamard) and encryption (e.g. AES). According to further embodiments of the present invention, the processed fine data set may be sent to the MIMO OFDM mapper (316) for some form of fine, constellation and/or shape symbol mapping.

According to some embodiments of the present invention, a symbol generated by the mapper (316) may be sent to a functionally associated or integral inverse discrete Fourier transformer (IDFT-320) for transforming the symbol into the time-domain. According to further embodiments of the present invention, a functionally associated or integral cyclic prefix inserter (322) may add a cyclic prefix to the symbol. According to further embodiments of the present invention, a functionally associated or integral preamble mux (326) may receive the symbol in addition to a preamble received from a functionally associated or integral preamble inserter (324). According to further embodiments of the present invention, a functionally associated or integral symbol shaper (328) may receive the data from the preamble mux (326) and process the data for transmission suitability (e.g. to avoid intersymbol interference). The shaped data may be sent to a functionally associated analog and RF processor (330) for modulation, up-converting and transmitting.

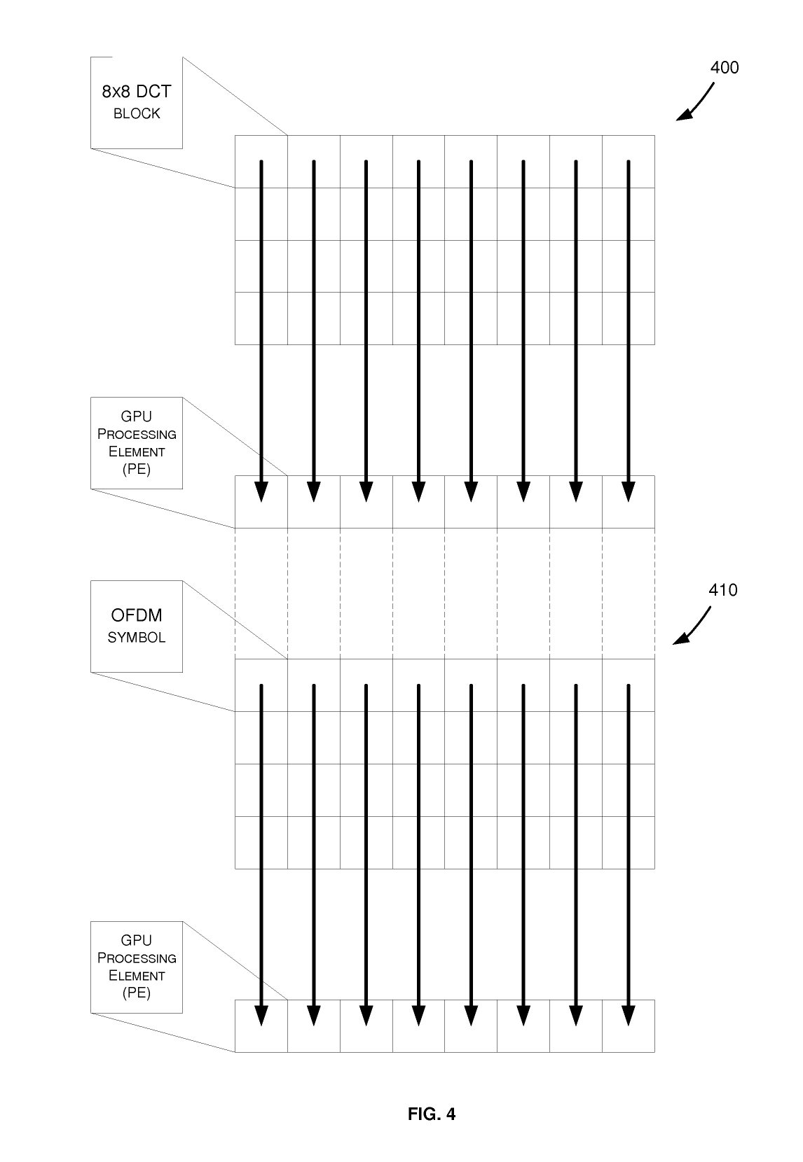

Now turning to FIG. 4, there is shown a schematic diagram showing computational parallelization in a GPU according to some embodiments of the present invention. According to some embodiments of the present invention, de-correlated data coefficient generation and transmission symbol processing may be a two phase operation. According to further embodiments of the present invention, a video/audio content frame may be processed as an independent sequence of 8×8 pixel blocks (400). DCT processing on the blocks may be run in a parallel processing mode generating multiple streams of processed data. According to further embodiments of the present invention, the streams may be mapped as independent sequences of transmission (e.g. OFDM) symbols (410). Transmission symbols processed in a parallel scheme may be recombined or reformatted by a functionally associated or integral circuit, logic or device.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A circuit for transmitting video/audio content from a computing or communications device comprising:
a shared computational resource adapted to intercept the video/audio content and convert the content into transmission symbols; and
a communication resource adapted to up-convert and transmit the transmission symbols.

2. The circuit according to claim 1, wherein the video/audio content is intercepted as data frame spatial coefficients or a compressed representation of data frame spatial coefficients.

3. The circuit according to claim 2, wherein the shared computational resource is further adapted to map the data frame spatial coefficients to a transmission symbol map.

4. The circuit according to claim 3, wherein the shared computational resource is selected from the group consisting of a mobile device application processor, a personal computer processor, a mobile device graphics processor, a personal computer graphics processor, a desk-top-box graphics processor, a desk-top-box applications processor, a digital signal processor, a discrete transform engine, a transmitter baseband processor, a programmable gate array, a field programmable gate array and an application specific integrated circuit.

5. The circuit according to claim 1, wherein the video/audio content is intercepted as pixel data.

6. The circuit according to claim 5, wherein the shared computational resource is further adapted to generate data frame spatial coefficients by processing blocks of pixel data through a de-correlating transform.

7. The circuit according to claim 6, wherein the de-correlating transform is a discrete cosine transform.

8. The circuit according to claim 5, wherein the shared computational resource is further adapted to map the data frame coefficients to a transmission symbol map.

9. The circuit according to claim 5, wherein the shared computational resource is selected from the group consisting of a mobile device application processor, a personal computer processor, a mobile device graphics processor, a personal computer graphics processor, a desk-top-box graphics processor, a desk-top-box applications processor, a digital signal processor, a discrete transform engine, a transmitter baseband processor, a programmable gate array, a field programmable gate array and an application specific integrated circuit.

10. The circuit according to claim 9, wherein said shared computational resource is a graphics processor adapted for parallel processing.

11. The circuit according to claim 10, wherein said graphics processor is adapted to perform pixel block processing or transmission symbol processing in parallel.

12. The circuit according to claim 1, wherein the communication resource is a shared transmitter.

13. The circuit according to claim 12, wherein the shared transmitter includes a shared radio frequency integrated circuit (RFIC).

14. The circuit according to claim 13, wherein the shared transmitter includes a shared baseband integrated circuit (BBIC).

15. The circuit according to claim 12, wherein the communication resource is adapted to be an orthogonal frequency-division multiplexing (OFDM) transmitter.

16. A computing device comprising:
a shared computational resource adapted to intercept the video/audio content and convert the content into transmission symbols; and
a communication resource adapted to up-convert and transmit the transmission symbols.

17-30. (canceled)

31. A communications device comprising:
a shared computational resource adapted to intercept the video/audio content and convert the content into transmission symbols; and
a communication resource adapted to up-convert and transmit the transmission symbols.

32. The communications device according to claim 31, wherein the video/audio content is intercepted as data frame spatial coefficients or a compressed representation of data frame spatial coefficients.

33. The communications device according to claim 32, wherein the shared computational resource is further adapted to map the data frame spatial coefficients to a transmission symbol map.

34. The communications device according to claim 33, wherein the shared computational resource is selected from the group consisting of a mobile device application processor, a personal computer processor, a mobile device graphics processor, a personal computer graphics processor, a desk-top-box graphics processor, a desk-top-box applications processor, a digital signal processor, a discrete transform engine, a transmitter baseband processor, a programmable gate array, a field programmable gate array and an application specific integrated circuit.

35-45. (canceled)
